(19) United States
(12) Patent Application Publication
(10) Pub. No.: US 2009/0283109 A1
(43) Pub. Date: Nov. 19, 2009

(54) Methods for Cleaning and Curing Solid Freeform Fabrication Parts

(76) Inventors: Khalil Moussa, Charlotte, NC (US); Abraham N. Reichental, Simpsonville, SC (US); Charles R. Sperry, Leeds, MA (US); Dennis F. McNamara, Charlestown, NH (US); Suzanne M. Scott, Springfield, VT (US); Krzysztof J. Muskus, Keene, NH (US)

Correspondence Address: 3D Systems, Inc.;Attn: Keith A. Roberson, 333 Three D Systems Circle, Rock Hill, SC, 29730, US

(21) Appl. No.: 12/122,360

(22) Filed: May 16, 2008

(51) Int. Cl. B08B 3/10; B08B 3/04

(52) U.S. Cl. 134/1; 134/33

(57) ABSTRACT

A post-processing system is provided for cleaning and/or curing a part produced by solid freeform fabrication (SFF). The post-processing systems include a housing, a part retaining device to retain the part within the housing, and an actinic radiation source to cure the part with actinic radiation. The systems also include a fluid circulation device adapted to expose the part to cleaning fluid and/or to allow the cleaning fluid to absorb actinic radiation to permit filtration of removed build material to allow extended use of the cleaning fluid. Certain systems include a first rotating portion that can rotate the retained part about a first axis, and further systems include a second rotating portion that can rotate the retained part about a second axis. The systems also include additional features to provide safe and efficient cleaning and/or curing of parts produced by SFF.

### FIELD OF THE INVENTION

The present invention is related to the creation of three dimensional parts produced by solid freeform fabrication, and more particularly, to systems that clean and/or cure parts produced by solid freeform fabrication.

### BACKGROUND OF THE INVENTION

A number of technologies presently exist for the rapid creation of models, prototypes, and parts for limited run manufacturing. These technologies are generally called Solid Freeform Fabrication techniques, and are herein referred to as “SFF.” Some SFF techniques include stereolithography, selective deposition modeling, laminated object manufacturing, selective phase area deposition, multi-phase jet solidification, ballistic particle manufacturing, fused deposition modeling, particle deposition, laser sintering, film transfer imaging, and the like. Generally in SFF, complex parts are produced from a build material in an additive fashion as opposed to conventional fabrication techniques, which are generally subtractive in nature. For example, in most conventional fabrication techniques material is removed by machining operations or shaped in a die or mold to near net shape and then trimmed. In contrast, additive fabrication techniques incrementally add portions of a build material to targeted locations, layer by layer, in order to build a complex part. SFF technologies typically utilize a computer graphic representation of a part and a supply of a build material to fabricate the part in successive layers. SFF technologies have many advantages over conventional manufacturing methods. For instance, SFF technologies dramatically shorten the time to develop prototype parts and can produce limited numbers of parts in rapid manufacturing processes. They also eliminate the need for complex tooling and machining associated with conventional subtractive manufacturing methods, including the need to create molds for custom applications. In addition, customized objects can be directly produced from computer graphic data in SFF techniques.

Generally, in most techniques of SFF, structures are formed in a layer by layer manner by solidifying or curing successive layers of a build material. For example, in stereolithography a tightly focused beam of energy, typically in the ultraviolet radiation band, is scanned across sequential layers of a liquid photopolymer resin to selectively cure resin of each layer to form a multilayered part. In selective laser sintering a tightly focused beam of energy, such as a laser beam, is scanned across sequential layers of powder material to sinter or melt powder of each layer to form a multilayered part. In selective deposition modeling, a build material is jetted or dropped in discrete droplets, or extruded through a nozzle, such that the build material becomes relatively rigid upon a change in temperature and/or exposure to actinic radiation in order to build up a three-dimensional part in a layerwise fashion. In film transfer imaging, a film transfers the resin to an image plane area where portions of the resin corresponding to the cross-sectional layer of the part are cured with actinic radiation to form one layer of a multilayer part. These and other techniques of SFF often produce a “green” part that has not been fully cured and/or has not been cleaned for a number of reasons, including but not limited to increasing the speed with which the SFF system is able to produce parts.

The green part produced by SFF often requires post-processing steps such as cleaning the part, curing the part, and/or the removing of support material to convert the green part to a final model, prototype, manufactured good, or the like. The post-processing can be manual labor intensive and/or may include a number of different systems to perform each step of the post-processing. Furthermore, handling of the green parts during the post-processing often requires a skilled technician as many green parts include uncured build material that should not contact the technician's skin or the green parts may comprise fragile portions that could be damaged or broken prior to the full cure of the post-process operation. Therefore, needs exist for improved post-processing of parts produced by SFF.

### BRIEF SUMMARY OF THE INVENTION

The present invention comprises apparatuses and methods that include many aspects adapted to improve the post-processing of parts produced by SFF. This summary recites a few of the non-limiting aspects of the present invention. One aspect of the invention is a post-processing system and associated methods that enable the convenient cleaning and curing of a “green” part with a single system. The post-processing system includes a housing that is substantially watertight when a door is in the closed position. A part retaining device within the housing retains the part within the housing during the cleaning and/or curing of the part. The post-processing system also includes a fluid circulation device that exposes the part to a cleaning fluid so that the cleaning fluid removes any uncured build material that may remain on the part after the SFF process. The post-processing system also includes an actinic radiation source in optical communication with the part so that the green part is cured to define the finished part. Using this apparatus and/or method, a technician is able to clean and cure a part without removing the part from the housing. The post-processing system and methods include additional and/or alternative features as described more fully in the following detailed description

Another aspect of the invention is a post-processing system that includes first and second rotating portions that rotate the part about two axes within the housing. By rotating the part about two axes, the part is cleaned more evenly and/or fully by the cleaning fluid circulated within the housing, and/or the part is cured more evenly and/or fully by the actinic radiation. Using such an apparatus and/or method decreases the post-processing time and/or improves the quality of the post-processing by obviating the previous need for a technician to reposition the part within the prior art post-processing system to achieve an adequate exposure of the part to cleaning fluid and/or an adequate cure of all sides of the part.

A further aspect of the invention includes a post-processing system and method for curing suspended particles of previously uncured build material that are removed from the part by the cleaning fluid. This curing of the particles can be performed during the curing of the part to reduce time and energy consumption, and the curing of the particles allows the particles to be filtered out of the cleaning fluid to extend the useful life of the cleaning fluid and thereby reduce the consumption of the cleaning fluid. Some embodiments of the present invention include a second fluid circulation device that circulates the cleaning fluid without substantially exposing the part to the cleaning fluid, as opposed to a first fluid circulation device that exposes the part to the cleaning fluid in order to remove the uncured build material from the part. The post-processing system and method of certain embodiments of the present invention disable the first fluid circulation device while the actinic radiation source is activated, so that while the part is being cured by the actinic radiation, the particles of previously uncured build material in the cleaning fluid are also cured while the cleaning fluid is being circulated by the second fluid circulation device. The post-processing system and methods include a filter that filters from the cleaning fluid the cured particles, and the filter can be selectively removed and replaced, refurbished, and/or cleaned as needed.

Still further embodiments of the invention include additional apparatuses and methods for improved post-processing of parts produced by SFF as disclosed in the detailed description below.

### BRIEF DESCRIPTION OF THE SEVERAL VIEWS OF THE DRAWINGS

Having thus described the invention in general terms, reference will now be made to the accompanying drawings, which are not necessarily drawn to scale and are meant to be illustrative and not limiting, and wherein:

FIG. 1 is a perspective view of a post-processing system in accordance with one embodiment of the present invention, illustrating the exterior of the housing, a door selectively defining a closed position, a control panel, and the exterior of an actinic radiation source;

FIG. 2 is a perspective view of a SFF system, more particularly a film transfer imaging system, in conjunction with the post-processing system of FIG.1, illustrating the movement of the part produced by SFF from a build pad to a part retaining device and into the post-processing system through a door selectively defining an open position;

FIG. 3 is a perspective view of the SFF system of FIG. 2 in conjunction with a post-processing system in accordance with a second embodiment of the present invention, illustrating a part handling device adapted to selectively remove the part from the SFF system and position the part in mechanical communication with the part retaining device of the post-processing system;

FIG. 4 is a perspective view of a post-processing system in accordance with another embodiment of the present invention with the exterior of the housing removed to illustrate a motor adapted to selectively rotate at least a first rotating portion of the post-processing system and to illustrate a cleaning fluid property detector and an orifice from which the cleaning fluid may be removed from the housing;

FIG. 5 is a perspective view of the post-processing system of FIG. 1, illustrating a part retaining device comprising a cage and lid assembly, a first rotating portion comprising a shaft that is selectively removable from the housing, a second rotating portion, a first fluid circulation device, a second fluid circulation device, and a filter;

FIG. 6 is a front perspective view of the post-processing system of FIG. 5 with the first rotating portion in an operational position within the housing, illustrating the rotation of the part (inside the part retaining device behind the lid) about a first axis relative to the housing and about a second axis relative to the housing and illustrating the exposure of the part to a cleaning fluid by the first fluid circulation device;

FIG. 7 is a front perspective view of the post-processing system of FIG. 6, illustrating the rotation of the part (inside the part retaining device behind the lid) about a first axis relative to the housing and about a second axis relative to the housing and illustrating the part being cured by actinic radiation (by being in optical communication with the actinic radiation source) and illustrating the cleaning fluid in optical communication with the actinic radiation source to cure particles of previously uncured build material removed from the part by the cleaning fluid, wherein the second fluid circulation device circulates the cleaning fluid in optical communication with the actinic radiation source without substantially exposing the part to the cleaning fluid, and wherein the filter is illustrated as having filtered the cured particles of build material;

FIG. 8 is an exploded perspective view of the part retaining device, the first rotating portion, and the second rotating portion of the post-processing system of FIGS. 5 to 7;

FIG. 9 is a perspective view of a part retaining device and a first rotating portion of a post-processing system of another embodiment of the present invention, wherein the part retaining device is adapted to selectively retain a build pad upon which the part was produced in the SFF system and to which the part is removably joined;

FIG. 10 is a perspective view of a post-processing system of a further embodiment of the present invention with the actinic radiation source suspended (and slightly rotated) above the housing of the post-processing system to illustrate a surface comprising a material that is substantially transparent to actinic radiation that is positioned between the actinic radiation source and the part and to illustrate the array of lamps that define an aperture to direct actinic radiation in the general direction of the part;

FIG. 11 is a perspective view of a post-processing system in accordance with yet another embodiment of the present invention, illustrating a receptacle adapted to receive a container of cleaning fluid, such that the cleaning fluid in the container is in selective fluid communication with the fluid circulation device and illustrating (in phantom) the connection of a container to the orifice (not shown) to facilitate the removal of the cleaning fluid from the housing and transfer of the cleaning fluid to the container;

FIG. 12 is a perspective view of a post-processing system in accordance with a further embodiment of the present invention, illustrating an RFID reader device adapted to receive information about the cleaning fluid from an RFID tag device associated with the container of cleaning fluid;

FIG. 13 is a perspective view of a post-processing system in accordance with still another embodiment of the present invention similar to the embodiment of FIG. 11 but also including a container of antifoam, wherein the post-processing system is adapted to mix a portion of antifoam with the cleaning fluid;

FIG. 14 is a front perspective view of an interior of a housing of a post-processing system of an additional embodiment of the present invention, illustrating air circulation devices adapted to selectively dry the part within the housing and illustrating a fluid removal device proximate the surface comprising material that is substantially transparent to actinic radiation, wherein the fluid removal device selectively removes cleaning fluid from the interior side of the surface;

FIG. 15 is a perspective view of a post-processing system in accordance with yet another embodiment of the present invention, illustrating the removal of part retaining device with first and second rotating portions and the installation of a part retaining device comprising a shelf;

FIG. 16 is a perspective view of the shelf of FIG. 15, wherein the shelf defines a part retaining device;

FIG. 17 is a perspective view of a filter for a post-processing device in accordance with some embodiments of the present invention, wherein the filter comprises a filtration portion and a housing portion, wherein each of the filtration portion and housing portion are flexible to an extent that each may be positioned under retaining lips of a recess in the housing of the post-processing system for selective retention within the housing;

FIG. 18 is a perspective view of a filter for a post-processing device in accordance with other embodiments of the present invention, wherein the filter comprises a filtration portion and a housing portion that are permanently joined together;

FIG. 19 is a perspective view of a filter for a post-processing device in accordance with further embodiments of the present invention, wherein the filter comprises a filtration portion and a housing portion and the filtration portion is adapted to be selectively received within the housing portion; and

FIG. 20 is a perspective view of a filter for a post-processing device in accordance with still further embodiments of the present invention, wherein the filter comprises a filtration portion and a housing portion, wherein the housing portion defines a handle to facilitate removal, handling, and/or installation of the filter.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although apparatus and methods for post-processing parts produced by solid freeform fabrication (SFF) are described and shown in the accompanying drawings with regard to specific types of parts made by film transfer imaging, it is envisioned that the functionality of the various apparatus and methods may be applied to any now known or hereafter devised SFF technique in which it is desired to clean and/or cure the part subsequent to the SFF process. Like numbers refer to like elements throughout.

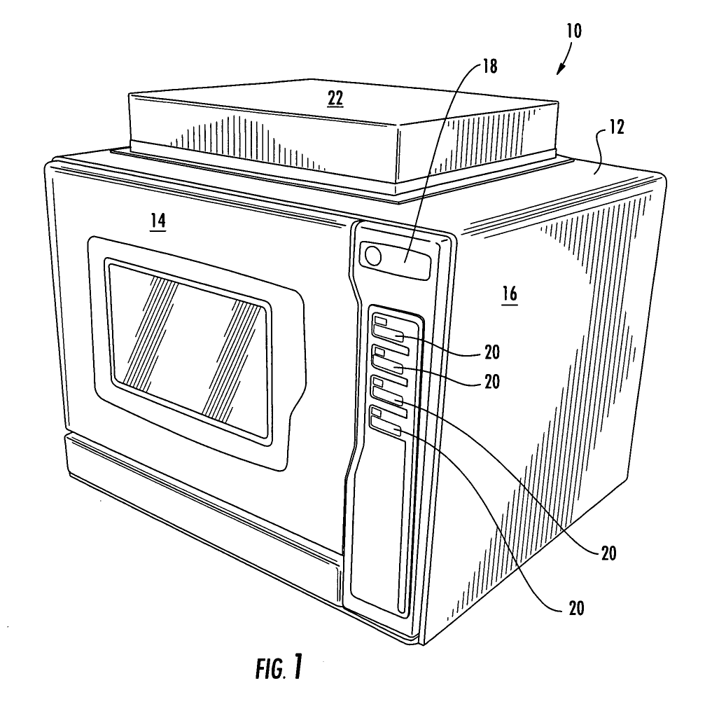

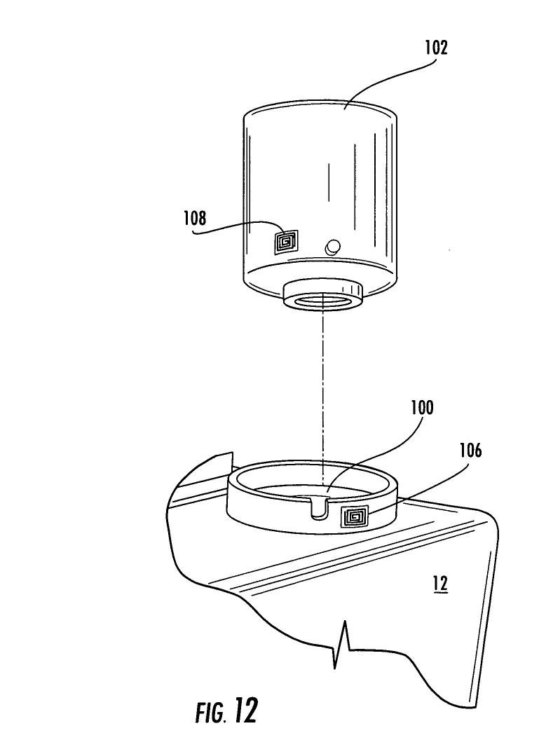

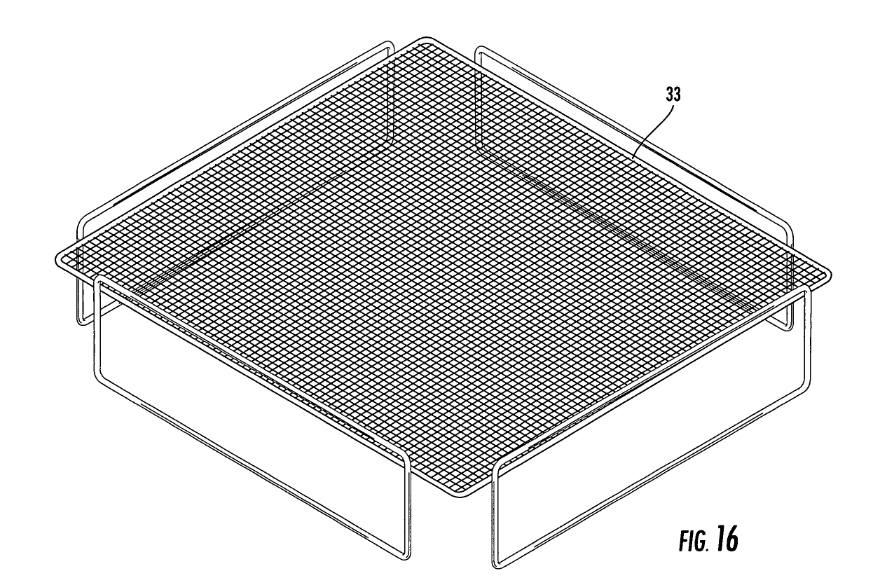

With reference to FIGS. 1 to 20, post-processing systems and associated systems and/or components in accordance with various embodiment of the present invention are illustrated. The term “post-processing” typically refers to various processes that the green part is subjected to subsequent to the SFF process and typically includes processes such as cleaning, curing, removing support structures, polishing, painting, assembling, and the like. The specific post-processes that the part is subjected to depends upon a number of factors including, but not limited to, the particular SFF process, the build material(s) of which the part consists, the material properties of the part desired (including but not limited to the tensile strength, surface finish, and the like), the cost and/or time constraints of the customer, and other factors. Therefore, it should be appreciated that the terms “post-processing” or “post-process” used herein do not require that any particular process or set of processes are required, but is used herein to generically refer to processes that occur subsequent to the completion of the green part by the respective SFF process.

It should also be appreciated that although the illustrated embodiments and following disclosure is directed to the cleaning and/or curing of a single part the apparatuses and methods of the present invention can be used to clean and/or cure any number of parts simultaneously and/or sequentially. Indeed, the present invention is directed to post-processing systems and related methods that cover any SFF process, many of which produce multiple parts simultaneously, and the present invention is intended to accommodate the size, shape, and/or number of parts produced by the SFF system in such a way as to improve the speed and/or efficiency of the cleaning and curing of the SFF-produced parts.

Turning now to the illustrated embodiments of the present invention, the part described herein is produced with a building material that is used in the film transfer imaging process of SFF. One exemplary formulation of the build material includes the following components: tricyclodecane dimethanol, urethane acrylate, polyester acrylate, and/or multifunctional and monofunctional acrylates, as well as photoinitiators such as 2-methyl-1-(4-methylthiophenyl)-2-morpholinopropan-1-one and/or phenl bis(2,4,6-trimethylbenzoyl)-phosphine oxide. Accordingly, the cleaning fluid described herein is 90 to 99% propylene carbonate (with an antifoam agent, such as BYK 1790, as needed) which has been shown to adequately remove the uncured build material from the part. It should be appreciated that any cleaning fluids may be used with the present invention, and such cleaning fluid should be correlated with the particular build material of the part to be cleaned to improve the efficiency of the cleaning process. One non-limiting example of alternative material and cleaning fluid include the cleaning of a part comprising a resin that is typically used in the stereolithography process of SFF. One exemplary resin includes the following components: ethylenically unsaturated monomer/oligomers, epoxy monomers (cycloaliphatic and glycidyl ether), polyols, radical photoinitiators, cationic photoinitiators, and stabilizers. Accordingly, the cleaning fluid used in the corresponding post-processing system would be propylene carbonate (PC), tripropylene glycol methyl ether (TPM), or isopropanol (IPA). Still further embodiments of the present invention clean and cure parts of alternative build material using alternative cleaning fluids.

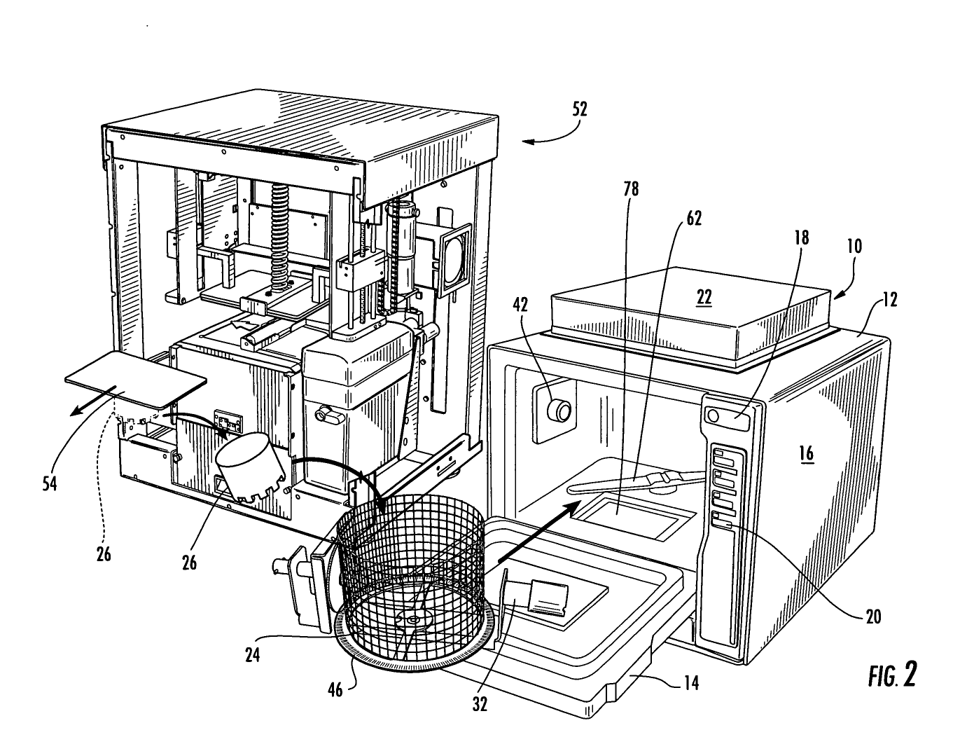

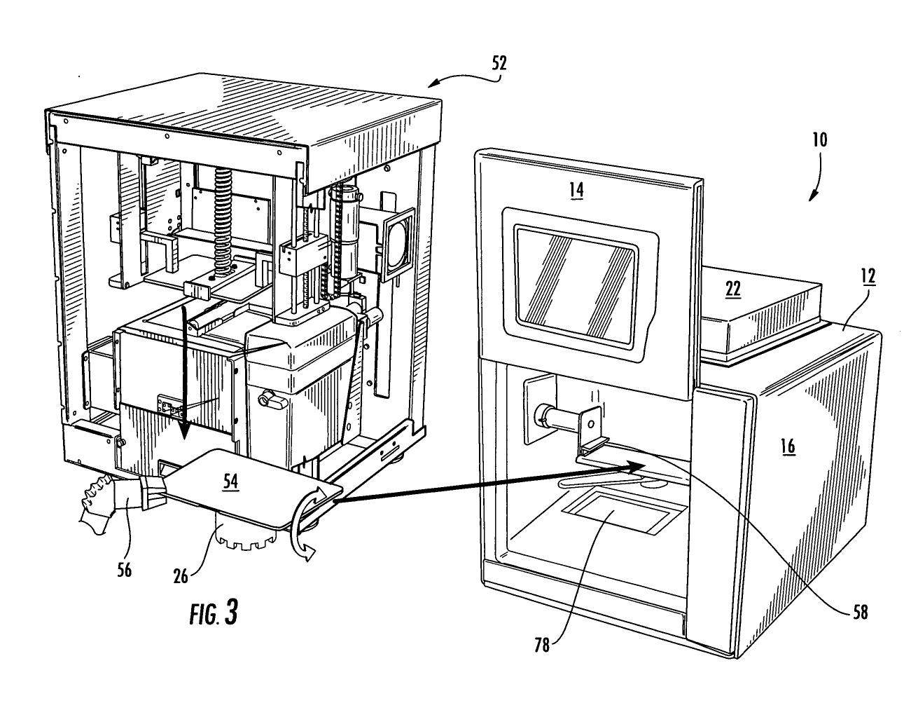

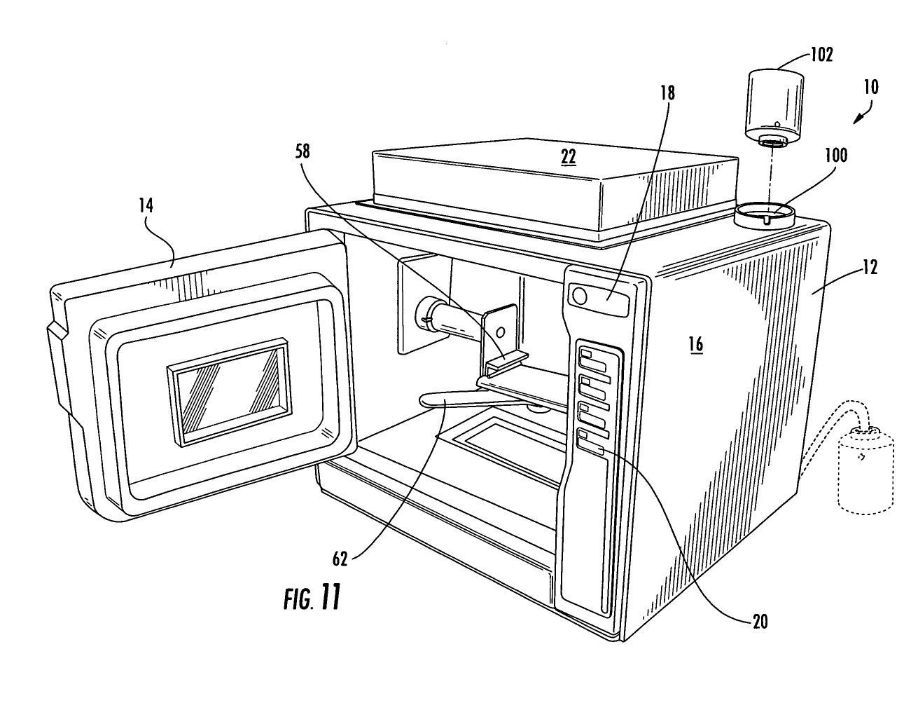

Turning now to the post-processing system 10 of FIG. 1, the post-processing system comprises a housing 12 that includes a door 1 4 and an exterior 16. The door 14 selectively defines an open position and a closed position, and the post-processing system 10 of FIG. 1 includes a button 18 to enable a technician to selectively open the door. The door 14 of the post-processing system 10 opens by rotating about a horizontal axis, as shown in FIG. 2 (in the open position); however, further embodiments of the present invention include doors that rotate about a vertical axis (as shown in FIG. 11), that slide in a direction that is generally orthogonal to an adjacent side of the housing (as shown in FIG. 3), or that move in other manners to convert the door from the closed position to the open position. The post-processing system 10 of FIG. 1 also includes at least one seal proximate the door to that the housing 12 is substantially watertight when the door 14 defines the closed position. By having a substantially watertight housing, cleaning fluid is prevented from leaking from the housing 12, such that cleaning fluid is conserved and technicians need to perform relatively little clean-up as compared to many prior art cleaning processes.

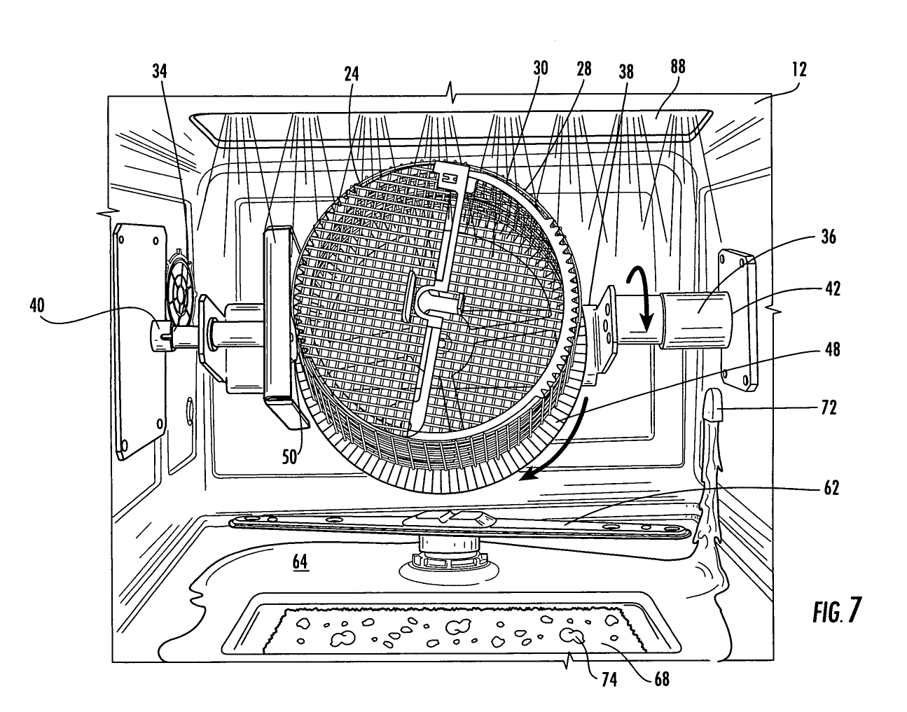

As shown in FIG. 1, the post-processing system 10 includes a series of four buttons that may be manually pushed by a technician. The four buttons 20 of a control panel of the post-processing system 10 correspond to the following four processes: 1) clean and cure part, 2) clean part, 3) cure part, and 4) rejuvenate cleaning fluid. It should be appreciated that the “rejuvenate” process is the circulation of the cleaning fluid in optical communication with the actinic radiation source so that particles of the previously uncured build material that are suspended, dissolved, or otherwise included in the cleaning fluid are cured so that the cured particles may be filtered from the cleaning fluid and thus “rejuvenate” the cleaning fluid by restoring at least a portion of its ability to removed uncured build material from the part to be cleaned. It should also be appreciated that the cleaning fluid can also be rejuvenated during the “clean and cure part” process and/or the “cure part” process as discussed more fully below, in particular with respect to FIG. 7. Further embodiments of the present invention may include additional and/or alternative buttons or controls or may include no buttons or controls such that the post-processing system is programmed to perform certain processes without the need for manual control. One non-limiting example of a post-processing system that would not require manual buttons or controls is the post-processing system 10 of FIG. 3 in which a part handling device is adapted to selectively position the part in the housing 12 and remove the part from the housing, such that no technician involvement is necessary.

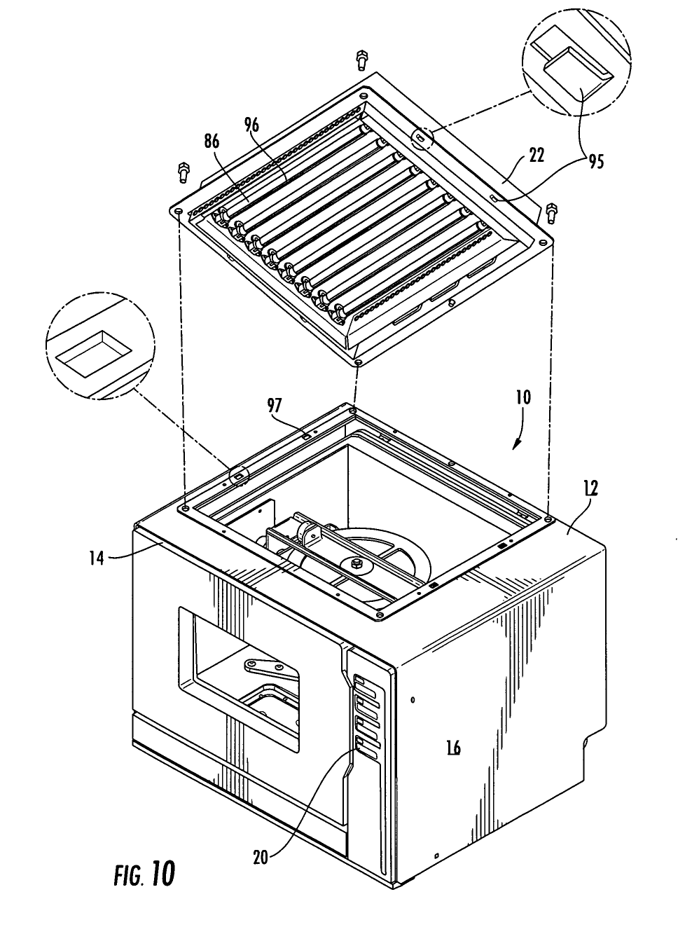

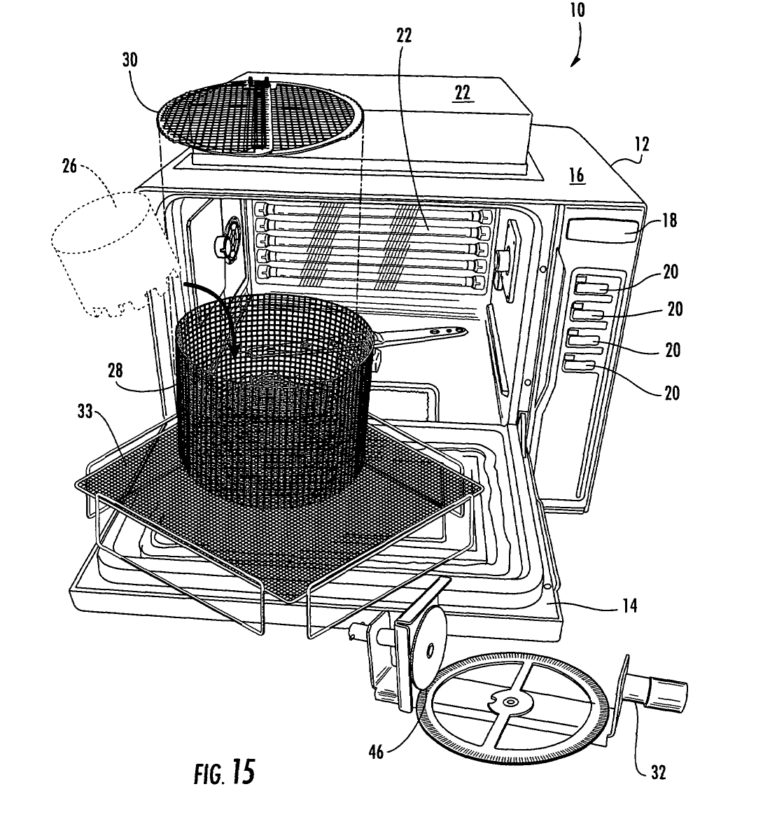

Turning again to FIG. 1, the post-processing system 10 also includes an actinic radiation source 22, which in the illustrated embodiment is mounted to the top of the housing, but in further embodiments may be position on any side of the housing (an example includes the back side of the housing as shown in FIG. 15). As described more fully below with respect to FIG. 10, the actinic radiation source 22 is in optical communication with the part when the part is within the housing, such that the part is cured by the actinic radiation. As used herein, “actinic radiation” includes any and all electromagnetic radiation that produces a photochemical reaction in the material that absorbs the electromagnetic radiation. Such actinic radiation includes, but is not limited to, radiation that results in cross-linking of any radiocrosslinkable material that absorbs the radiation. In certain embodiments of the present invention, the actinic radiation source includes radiation that changes the temperature of the material such that the cross-linking is at least partially facilitated by the change in temperature. In other embodiments of the present invention, such as the illustrated embodiments, the cross-linking of the material is facilitated substantially independently of changes in temperature of the radiocrosslinkable material. The illustrated embodiments of the present invention include an actinic radiation source 22 that comprises a plurality of fluorescent lamps (type 03 and/or type 05) emitting long-wave UV radiation between 300 and 480 nm, or more preferably between 350 and 420 nm. Although only one actinic radiation source 22 is illustrated in FIG. 1; further embodiments of the present invention include two or more separate actinic radiation sources, such as the embodiment of FIG. 15 which comprises a second actinic radiation source on a back side of the housing.

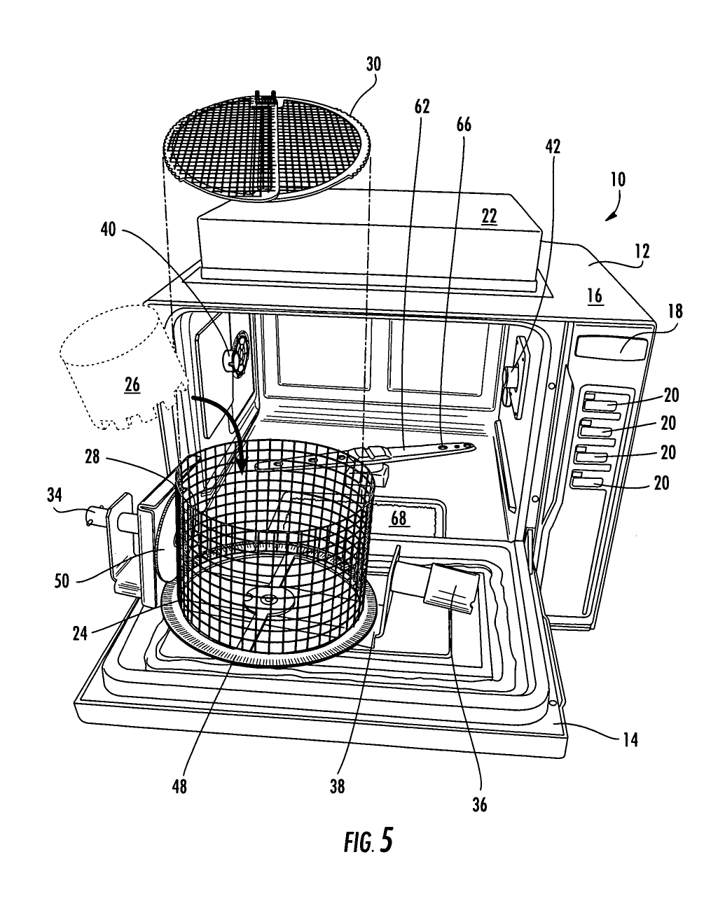

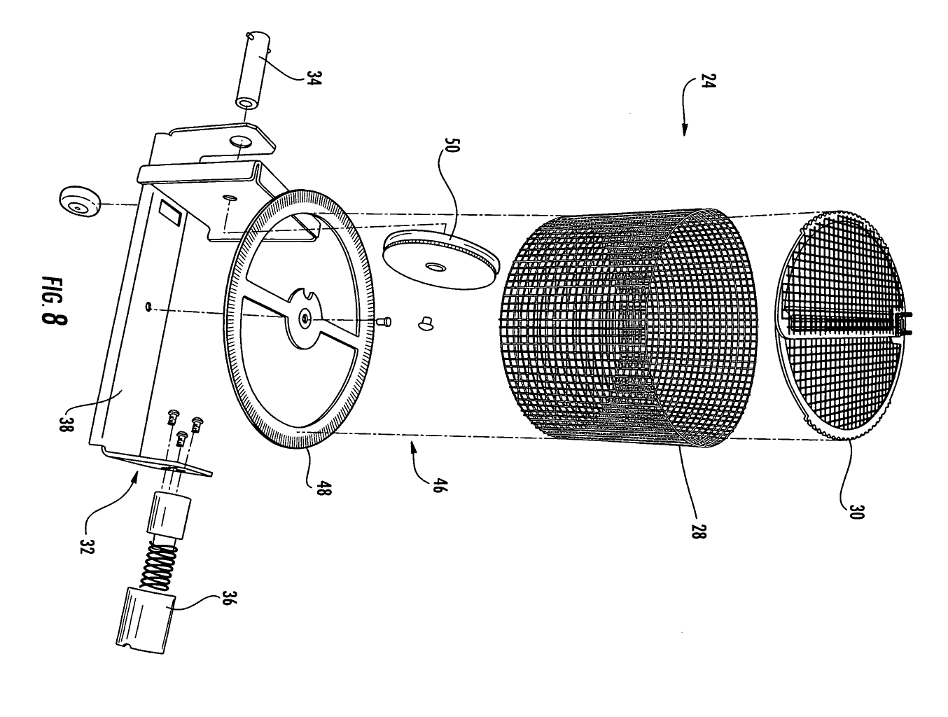

Turning now to FIG. 2, as well as FIGS. 5 and 8, the post-processing system 10 comprises a part retaining device 24 adapted to retain the part 26. The part retaining device 24 of FIG. 2 comprises a cage 28 and a lid 30. The technician places the part 26 into the cage 28 and then places the lid 30 within the cage in a position that generally restricts movement of the part relative to the part retaining device. The lid 30 of the illustrated embodiments is spring-loaded so that when the technician releases the lid, the lid exerts radially outward force on the insides surface of the cage to keep the lid generally in place. Accordingly, the post-processing system 10 is able to retain the part within the housing 12 and to move the part during the cleaning and/or curing process without substantially damaging the part 26. The part retaining device of the present invention may be any device that retains the part and need not include a cage and/or lid. The part retaining device of the various embodiments is generally open to allow the part to be exposed to the cleaning fluid and/or to absorb the actinic radiation. Accordingly, for the part retaining device 24, the cage 28 defines a mesh size that is adequate to retain the part while allowing a preferred amount of cleaning fluid and/or actinic radiation to pass through the walls of the cage. Similarly, the lid 30 defines openings to allow cleaning fluid and/or actinic radiation to pass through the lid while retaining the part 26 in the part retaining device.

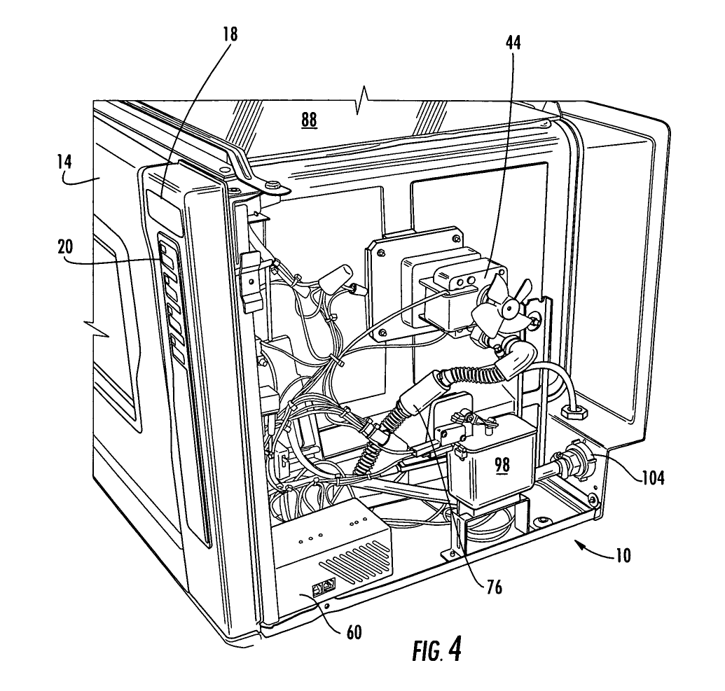

The part retaining device 24 of FIGS. 2, 5, and 8 is in mechanical communication with a first rotating portion 32 that in the illustrated embodiment comprises a shaft that extends from one side of the interior of the housing to an opposite side of the interior of the housing. The first rotating portion 32 is illustrated as being selectively removed from the housing, which in some embodiments simplifies the retaining of the part in the part retaining device. The first rotating portion 32 includes a first end 34 and a second end 36 separated by an offset portion 38 to which the part retaining device 24 is connected. The first end 34 is adapted to be retained by a first standoff 40 on the side of the interior of the housing. The first standoff 40 is stationary relative to the housing. The second end 36 of the first rotating portion 32 comprises a spring loaded collar adapted to be retained by a second standoff 42 on the opposite side of the interior of the housing. The second standoff 42 is selectively rotatable relative to the housing by a motor 44 mounted to the housing (illustrated in FIG. 4 in which the exterior of the housing has been removed for illustrative purposes). The spring-loaded collar of the second end 36 of the first rotating portion 32 allows the shaft to be selectively removable from the housing. The collar of the second end 36 engages the second standoff 42 with one or more pins or other comparable devices that enable to the second end to rotate with the second standoff when the motor is activated. The rotating second end 36 causes the offset portion 38 to also rotate about a horizontal axis, and the rotation of the offset portion causes the part retaining device 24 to similarly rotate about the horizontal axis. Accordingly, the first rotating portion 32 rotates the part 26 about a first axis relative to the housing. Still further embodiments of the present invention include alternative first rotating portions to rotate the part.

In mechanical communication with the first rotating portion 32 of FIGS. 2, 5, and 8 is a second rotating portion 46 that rotates the part about a second (and different) axis relative to the housing. The second rotating portion 46 of the illustrated embodiment is an assembly of two gears. A first gear 48 of the second rotating portion 46 is rotatably connected to the offset portion 38 of the first rotating portion 32. The part retaining device 24 is also connected to the first gear 48. The second gear 50 of the second rotating portion 46 is connected to the first end 34 of the first rotating portion 32 and is oriented generally orthogonal to the first gear 48. The teeth of the two gears 48, 50 interact while the first rotating portion 32 is rotating to cause the first gear 48 to rotate relative to the offset portion 38 to which first gear is connected. Accordingly, the part retaining device 24 and also the part 26 retained by the part retaining device rotate with the first gear 48 about a second axis that is generally orthogonal to the first axis. Therefore, the part 26 simultaneously rotates about the first axis and the second axis, which improves its exposure to the cleaning fluid and/or its absorption of the actinic radiation. Further embodiments of the present invention include alternative structures to enable the part to rotate about a second axis that is different than the first axis.

As shown in FIGS. 2, 5, and 8, the first rotating portion 32 (along with the second rotating portion 46 and the part retaining device 24) is selectively removable from the housing 12. By removing the first rotating portion 32 from within the housing, a technician can more easily place the part 26 in the part retaining device 24 and/or remove the part from the part retaining device. As mentioned above, the spring-loaded collar of the second end 36 of the first rotating portion 32 allows the shaft to be selectively removable from the housing. In addition, a technician can selectively remove the part retaining device 24 and/or the second rotating portion 46 from the first rotating portion 32 as needed to accommodate parts of various size and/or parts that require special curing and/or cleaning processes. Furthermore, removing the first rotating portion 32 from the housing 12 allows larger parts to be inserted into the post-processing system 10, such as on a removable shelf 33 (with or without the part retaining device 24) as shown in FIG. 15. However, by allowing larger parts 26 to fit in the post-processing system 10 without the first rotating portion 32, a technician using the post-processing system of FIGS. 2, 5, and 8 may be required to perform multiple cleaning and/or curing processes while moving the part to different orientations for each process. Therefore, the illustrated embodiment comprises a number of different ways of retaining and/or rotating the part within the post-processing system; and further embodiments of the present invention include additional and/or alternative ways to retain and/or rotate the part during cleaning and/or curing.

Turning again to FIG. 2, a method of removing the part 26 from a SFF system 52 and positioning the part in mechanical communication with the part retaining device 24 is illustrated. The SFF system 52 of FIG. 2 is a film transfer imaging system of the type disclosed in U.S. patent application Ser. No. 11/856,172 filed Sep. 17, 2007, which is assigned to the present assignee. The part 26 is built or produced layer by layer on the build pad 54. Once the part has been completely produced, the build pad 54 is removed along with the green part 26. The green part 26 of FIG. 2 is removed from the build pad 54 (and any support structures on the part may optionally be removed) and positioned in the part retaining device 24, which is then positioned in the housing 12 along with the first and second rotating portions as described above. Once the part 26 has been completely positioned in the housing, the technician manually closes the door 14 of the post-processing system 10 and then pushes the button 20 of the desired process. Once the selected process has completed, the technician pushes the button 18 to open the door 14 and then pulls on the spring-loaded collar of the second end 36 of the first rotating portion 32 to detach the first rotating portion from the second standoff 42 and then remove the first rotating portion. The technician may then remove the cleaned and/or cured part 26 from the part retaining device. Further embodiments of the present invention include additional and/or alternative methods and/or apparatuses for operating the post-processing system.

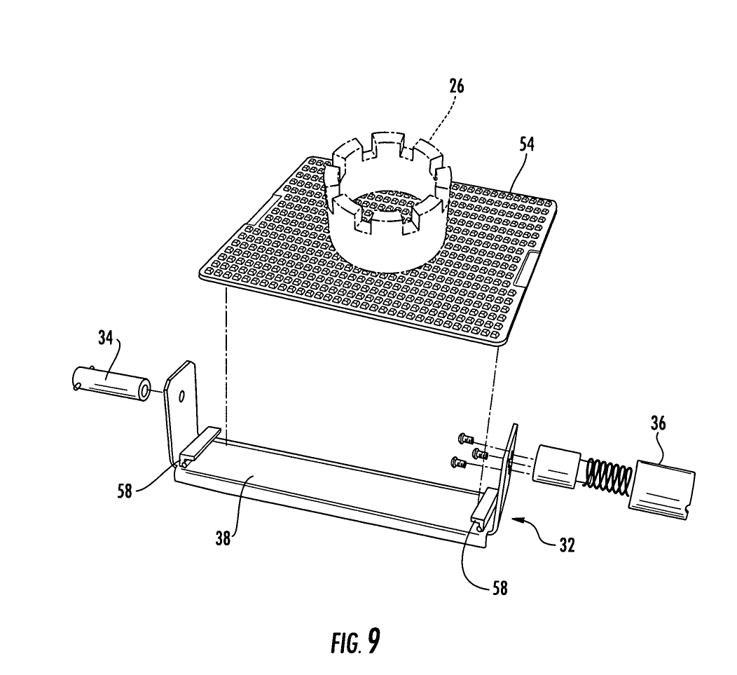

Referring now to FIG. 3, a fully automated process is disclosed. More specifically, a part handling device 56 selectively removes the build pad 54 (and part 26) from the SFF system 52 after the green part has been produced. The part handling device 56 positions the part in mechanical communication with the part retaining device 24 inside the housing 12 of the post-processing system 10. The part retaining device 24, which is also shown in FIG. 9, comprises clip portions 58 that are adapted to selectively retain the build pad 54 and thus the part 26. The embodiment of FIGS. 3 and 9 includes only a first rotating portion 32 such that the part 26 and build pad 54 are rotated about only a single axis during the cleaning and/or curing process; however, further embodiments of the present invention include a second rotating portion, that may or may not be similar to the second rotating portion of FIG. 8, to rotate the part about a second axis. After the part 26 has been positioned within the housing 12, the part handling device 56 is retracted and the door 14 is automatically moved to the closed position using appropriate actuation devices. Once the door 14 is in the closed position and the housing 12 is substantially watertight, the controller 60 (shown in FIG. 4) automatically starts the cleaning and/or curing process in accordance with what is required for the part 26. Once the cleaning and/or curing process has been completed, the controller 60 opens the door 14 and orients the first rotating portion 32 (and second rotating portion if included) so that the part handling device 56 can grasp the build pad 54 (and/or part 26) and disconnect the part from the part retaining device and then place the part in a desired location away from the SFF system 52 and/or post-processing system 10. Therefore, a fully automated process for producing and cleaning/curing parts is achieved with the present invention in such a way that a part may be produced while the immediately preceding part is being cleaned and/or cured. Still further embodiments of the present invention include additional components and/or methods to provide automated part handling, cleaning, and/or curing of parts produced by SFF.

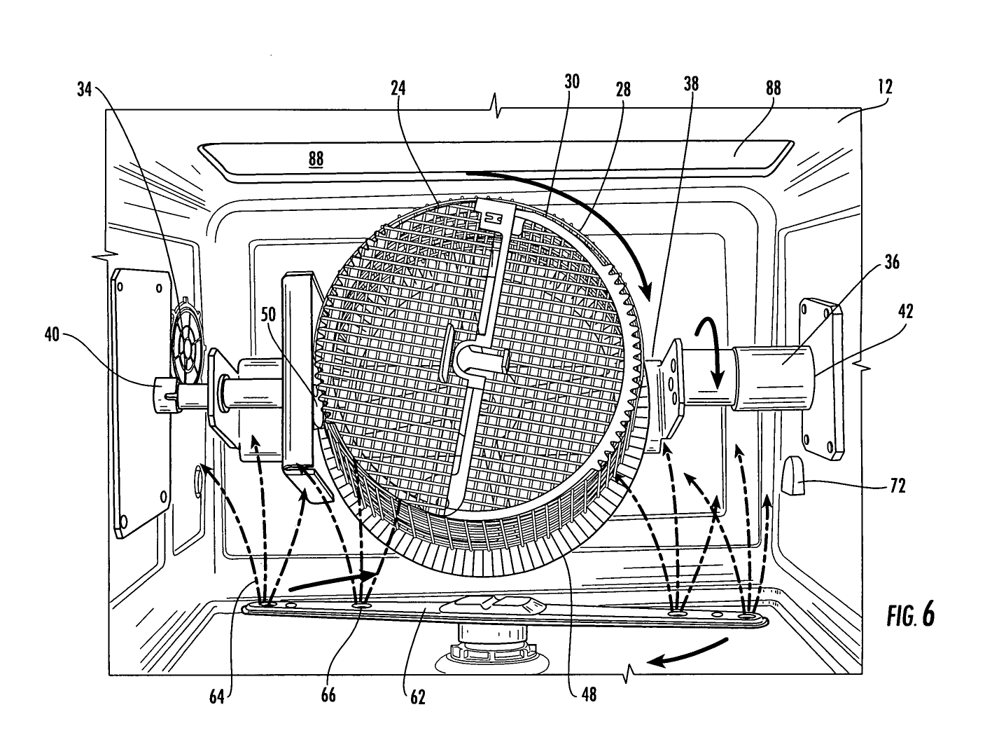

Turning now to the cleaning and curing of the part with the post-processing system, FIGS. 6 and 7 generally illustrate the cleaning and curing, respectively, of the part 26. Once the part 26 has been retained in the part retaining device 24 and/or the first rotating portion 32 has been installed within the housing 12, the technician closes the door and selects the process, such as the cleaning process illustrated in FIG. 6. During the cleaning process, which in the illustrated embodiment lasts for about six minutes, the first and second rotating portions 32, 46 rotate the part 26 about the first and second axes. While the part 26 is being rotated, a first fluid circulation device 62 exposes the part to a cleaning fluid 64. The first fluid circulation device 62 of the illustrated embodiment is similar to an agitator of the type used in dishwashing machines; however, further embodiments of the present invention comprise alternative fluid circulation devices, including but not limited to spray nozzles, gravity-fed dispensers positioned above the part, or any other device that exposes the part to the cleaning fluid. As used herein, “exposes” means the cleaning fluid comes into physical contact with the part so that at least a portion of uncured build material on a surface of the part is removed by the cleaning fluid. Turning again to the first fluid circulation device 62 of FIG. 6, the first fluid circulation device rotates about a generally horizontal axis and comprises an array of openings 66 through which pressurized cleaning fluid 64 is projected upward in order to expose the part 26 to the cleaning fluid.

As illustrated in FIGS. 5 and 7, a filter 68 is included in the housing 12 of the post-processing system 10. After the cleaning fluid 64 is projected upward by the first fluid circulation device 62, the cleaning fluid flows by gravity to the bottom of the interior of the housing and is pulled through the filter 68 to a pump that returns the pressurized cleaning fluid to the first fluid circulation device (or second fluid circulation device), thus defining a closed-loop for the cleaning fluid. Because the uncured build material removed from the part 26 by the cleaning fluid 64 is of a generally liquid or semi-liquid state, the filter generally does not retain most of the removed build material, yet the filter does prevent debris or other particles from adversely affecting the pump or hoses of the post-processing system 10.

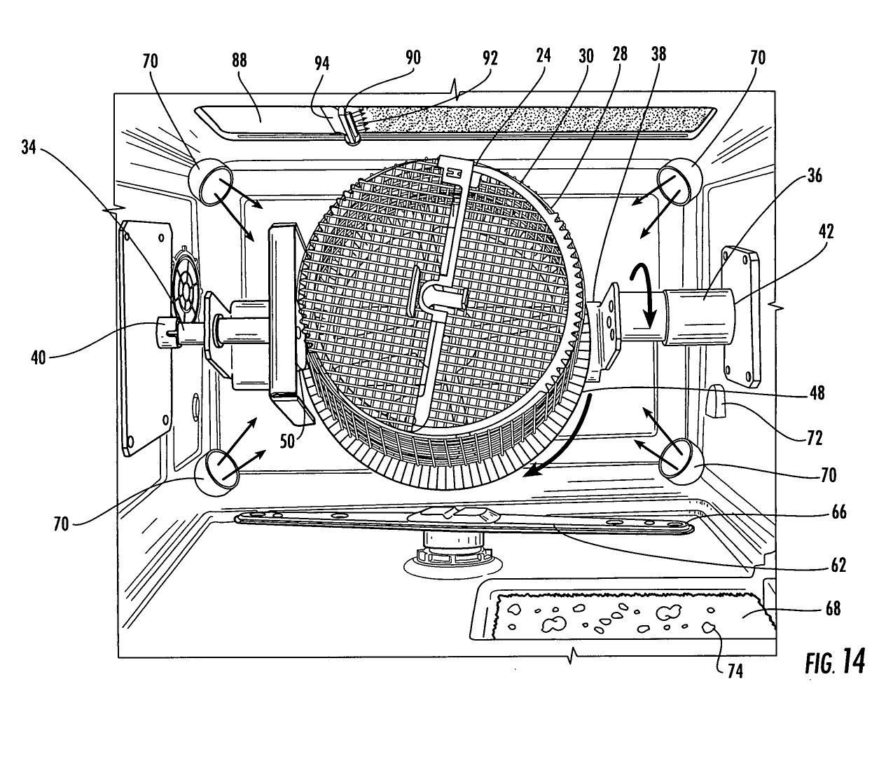

After the cleaning process has been completed, some embodiments of the present invention allow the part to dry prior to curing the part. The part 26 may be rotated by the first rotating portion 32 to allow the residual cleaning fluid on the part to be propelled away by the rotational forces, may be allowed to drip dry, and/or may be dried with a dryer device 70. The dryer device 70 of the illustrated embodiment of FIG. 14 comprises a plurality of air circulation devices; however, further embodiments of the present invention include alternative dryer devices, such a heater devices to recite one non-limiting example. Still further embodiments of the present invention, such as the embodiment of FIGS. 6 and 7, do not include a dryer device.

The curing process of the post-processing system 10 is generally illustrated in FIG. 7. The first rotating portion 32 and second rotating portion 46 rotate the part 26 about the first and second axes, respectively, while the actinic radiation source 22 is activated to cure the part. The rotation of the part 26 allows the radiation to be absorbed by the surfaces of the part (though some surfaces and/or portions of surfaces of the part may be eclipsed by the part retaining device and/or the first and second rotating devices) such that the part is sufficiently cured to a sufficient depth. Cure times vary based upon the size, thickness, material properties, etc. of the part, but a cure time of ten minutes is sufficient in one exemplary embodiment of the present invention. While the actinic radiation source 22 is on, the first fluid circulation device 62 is deactivated so that while the part is being cured, the part 26is not exposed to the cleaning fluid 64. Exposing the part to the cleaning fluid 64 during curing could cause uncured build material suspended in the cleaning fluid to be cured while the cleaning fluid/build material is in contact with the part, such that the surface of the part would be undesirably covered with cured particles of previously removed build material.

Therefore, the cleaning fluid 64 is circulated by only the second fluid circulation device 72, which selectively circulates the cleaning fluid without substantially exposing the part to the cleaning fluid. As shown in FIG. 7, the cleaning fluid 64 is deposited from the second fluid circulation device 72 and as the cleaning fluid collects in the bottom of the housing, it absorbs a certain amount of actinic radiation from the actinic radiation source 22. The previously uncured particles of build material removed by the cleaning fluid 64 are cured as they absorb the actinic radiation, and the cured particles 74 are captured by the filter 68 at the bottom of the housing. As shown in FIG. 4, the post-processing system 10 of certain embodiments also includes an in-line filter 76 to filter particles of cured build material. The in-line filter 76 may be positioned behind a convenient access panel (not shown) to allow a technician to selectively remove the in-line filter without substantial spilling of the cleaning fluid. Therefore, various embodiments of the present invention include one or both of the filter 68 and in-line filter 76.

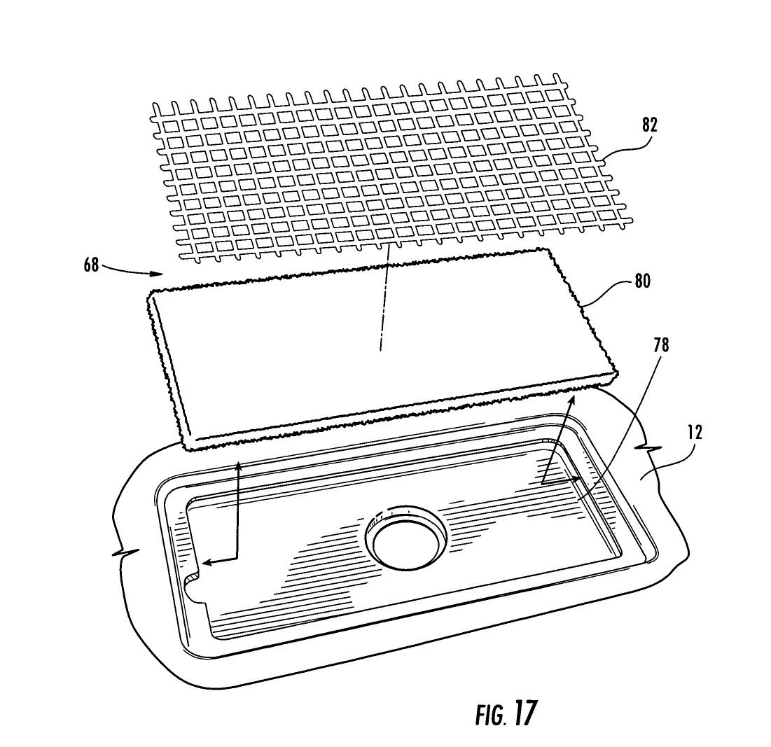

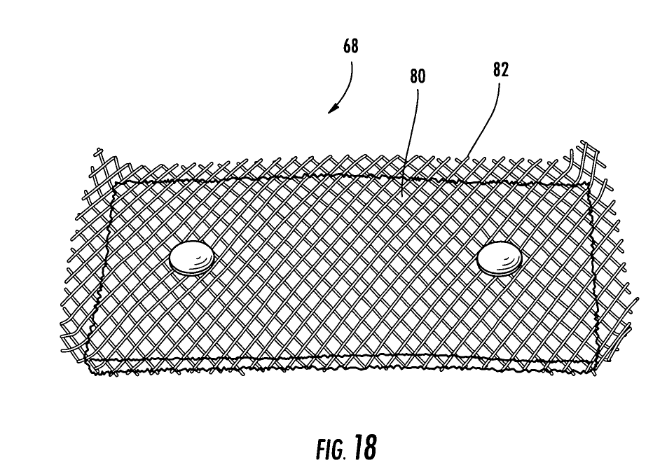

Turning now to the filters of FIGS. 17 to 20, various embodiments of the present invention include different filters that are adapted to be selectively removable from the recess 78 in the bottom of the interior of the housing 12. FIG. 17 illustrates a filter 68 comprising a filtration portion 80 and a housing portion 82, wherein the housing portion simply defines a flexible mesh surface. The recess 78 of FIG. 17 comprises an opening with a lip to receive the filtration portion 80 first and then the housing portion 82, such that the technician bends the mesh portion so that it is received under the lip to selectively retain both the housing portion and the filtration portion. To remove the filter 68, the technician simply bends the housing portion 82 to access and remove the filtration portion. The technician may then discard and replace or may clean and reuse the filtration portion. Similarly, FIG. 18 illustrates a filter 68 having a housing portion 82 that is permanently joined to the filtration portion 80. The filter 68 of FIG. 18 is retained in the recess 78 in a similar fashion to the filter of FIG. 17; however, the housing portion of the filter of FIG. 18 must be replaced or reused along with the filtration portion.

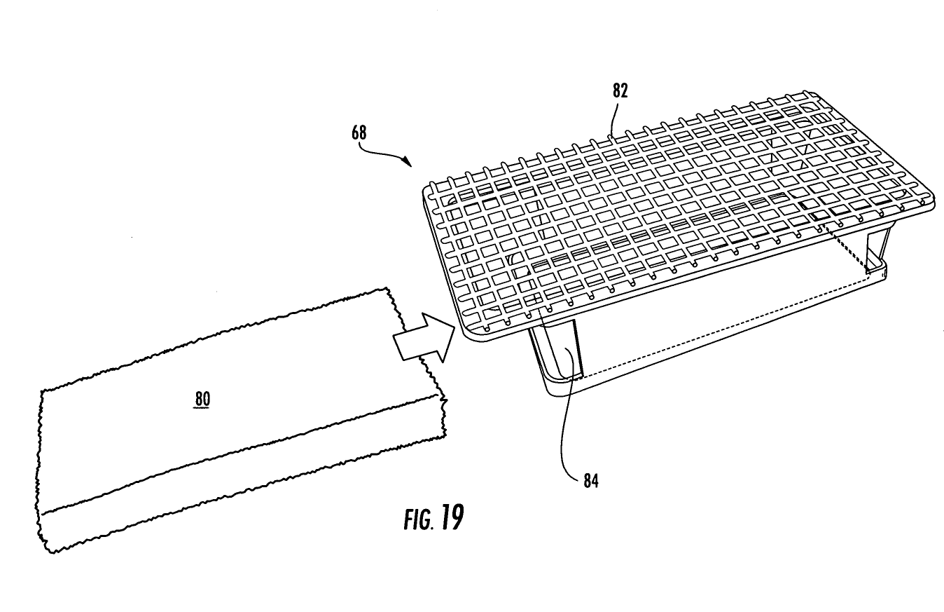

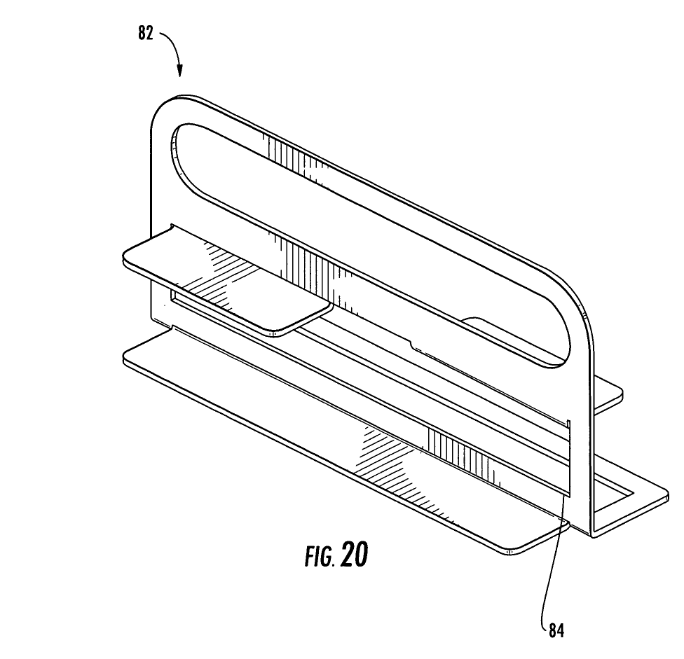

A further embodiment of a filter 68 is shown in FIG. 19, wherein the housing portion 82 comprises an opening 84 to receive the filtration portion 80. The upper surface (the mesh surface) of the filter 68 may be retained in the recess 78 by a lip or other similar structure or by a hook device, clamping device, or the like, to provide non-limiting examples of alternative retention features for the filter. Yet another embodiment of a filter 68 is provided in FIG. 20, which illustrates a housing portion 82 defining an opening 84 that receives a filtration portion (not shown) that defines a longitudinal length greater than the longitudinal length of the opening, such that filter is retained in the opening by the resilient nature of the filter material. The housing portion 82 further comprises a handle for convenient handling of the filter. Still further embodiments of the present invention include alternative filter designs.

Turning again to the actinic radiation source 22, FIG. 10 provides a detailed view of the actinic radiation source elevated above the housing for illustrative purposes. FIG. 10 illustrates the lamps 86 of the actinic radiation source and a surface 88 of the interior of the housing. The surface 88 comprises a material that is substantially transparent to the actinic radiation produced by the actinic radiation source 22. The surface is “substantially transparent” in that it allows electromagnetic radiation that is in the general frequency range required to cure the part to pass through the surface. The surface 88 is positioned between the actinic radiation source 22 and the part 26 and prevents the cleaning fluid 64 from contacting the actinic radiation source. Because cleaning fluid 64 may collect on the interior side of the surface 88 and over a period of time cured particles of build material in the cleaning fluid may adhere to the interior side of the surface 88, certain embodiments of the present invention, such as the embodiment of FIG. 14, comprise a fluid removal device 90 proximate the surface 88 to selectively remove cleaning fluid from the surface. The fluid removal device 90 removes the cleaning fluid 64 after the cleaning process has concluded and before the curing process has begun, such that substantially no cleaning fluid is on the interior side of the surface 88 when the actinic radiation source is activated for the cure process. The fluid removal device 90 of FIG. 14 comprises an air knife 92 and wiper 94 assembly that moves across the surface 88 to remove the cleaning fluid 64; however, further embodiments of the present invention include alternative fluid removal devices.

The actinic radiation source 22 of FIG. 10 comprises an array of eight lamps 86 of the type described above. The actinic radiation source 22 may comprise any number of arrays and/or number of lamps to provide the desired amount of actinic radiation. Further embodiments of the present invention include alternative actinic radiation sources, including by not limited to xenon lamps, LEDs, and the like. The lamps 86 of FIG. 10 include an aperture 96 in the coating of the lamp that directs actinic radiation in the general direction of the part. Furthermore, the actinic radiation source 22 includes a surface opposite the part from the lamps that reflects a portion of the actinic radiation back in the direction of the part. The actinic radiation sources 22 of the illustrated embodiments, including the actinic radiation source on the back wall of the housing 12 of FIG. 15, are adapted to be conveniently separated from the housing to enable technicians to replace lamps 86 as needed. For example, the actinic radiation source 22 of FIG. 10 may be removed by unfastening four fasteners and sliding the actinic radiation source 22 relative to the housing 12 so that the fingers 95 on the actinic radiation source may be disconnected from the slots 97 of the housing to allow the actinic radiation source to be lifted away from the housing. The actinic radiation source 22 may also be installed by reversing the process. In addition, the two-part design of the post-processing system 10 of FIG. 10 allows the post-processing system to be shipped as a two-piece assembly (shipped in either one or two cartons) that can be quickly and easily assembled at the end user's facility. Still further embodiments include additional and/or alternative features for connecting the actinic radiation source to the housing of the post-processing system.

Turning now to the cleaning fluid system of the post-processing system 10 of the present invention, the cleaning fluid defines a closed loop as discussed above. However, the post-processing system 10 requires a minimum amount of cleaning fluid 64 in order for the first and/or second fluid circulation devices 62, 72 to operate. Therefore, periodically the post-processing system 10 must have new cleaning fluid added to the system to replenish cleaning fluid that is lost during normal operation (during removal of part and/or first rotating portion, removal of filters, etc.) or cleaning fluid that needs to be replaced due to age or decreased effectiveness. The post-processing system 10 includes a cleaning fluid property detector 98 that determines at least one of the cleaning fluid level inside the housing, the quality of the cleaning fluid, the general age of the cleaning fluid, or other properties that contribute to the cleaning of the parts. The post-processing system 10 of FIGS. 11 to 13 includes a receptacle 100 adapted to receive a container 102 of cleaning fluid, such that the cleaning fluid in the container is in selective fluid communication with the fluid circulation device. More specifically, the post-processing system 10 of some embodiments comprises a cleaning fluid release device (not shown) that is any mechanical structure that allows cleaning fluid from inside the container of cleaning fluid to be released from the container so that the released cleaning fluid is in fluid communication with the fluid circulation device without manual intervention by a technician or operator. The cleaning fluid release device of certain embodiments of the present invention includes a solenoid-type actuator that when activated moves a valve in fluid communication with the container to allow a certain amount of cleaning fluid to be released, by gravity or positive pressure or the like, from the container. Still further embodiments of the present invention include alternative cleaning fluid release devices that provide for the release of cleaning fluid without manual intervention. The combination of the cleaning fluid property detector 98 and the cleaning fluid release device enables the post-processing system 10 to maintain desired levels of cleaning fluid without substantial involvement of a technician. Even further embodiments of the present invention include no cleaning fluid property detector and/or cleaning fluid release device, such that a technician or operator determines when the cleaning fluid should be replaced, supplemented, or the like and/or the technician or operator manually removes the old cleaning fluid from the housing and/or adds new cleaning fluid to the housing.

The post-processing system 10 of FIGS. 11 to 13 also includes an orifice 104 (shown in FIG. 4) from which the cleaning fluid may be removed from the housing 12 and transferred to a container, such as the type of container that is used to fill the post-processing system. The cleaning fluid property detector 98 can detect when the entire supply (or a portion of the supply) of cleaning fluid needs to be replaced to improve the cleaning efficiency of the post-processing system 10. When the controller 60 determines that the cleaning fluid needs to be replaced as a result of one or more material properties measured by the cleaning fluid property detector 98, the controller actuates a cleaning fluid drain device to cause the old cleaning fluid to be pumped out the orifice 104 into the disposal container. Once the old cleaning fluid has been drained, the controller 60 actuates the cleaning fluid release device to allow a certain amount of cleaning fluid 64 to be released from the container 102 and into the closed loop system of cleaning fluid used to clean the part.

Because the controller is able to automatically replenish and/or replace cleaning fluid from the container 102, certain embodiments of the present invention include an RFID reader device 106 mounted proximate the receptacle 100, such that the RFID reader device is adapted to receive information about the cleaning fluid from an RFID tag device 108 associated with the container of cleaning fluid. The RFID tag device 108 may be an active, semi-active, or passive tag that includes information about the cleaning fluid 64 inside the container. Such information includes, but is not limited to, the amount of cleaning fluid in the container, the type of cleaning fluid in the container, the age of the cleaning fluid, and the like. As the cleaning fluid release device, in conjunction with the controller, of the post-processing system is able to determine the amount of cleaning fluid released from the container, the RFID reader device 106 is able to write updated information to the RFID tag device 108 to maintain current information on the RFID tag device. The RFID devices may also be used to prevent undesirable mixing of cleaning fluids, as the post-processing systems of certain embodiments of the present invention are adapted for use with a number of different types of cleaning fluids, but a technician may inadvertently provide a container of a different cleaning fluid from what is in the post-processing system. In such a situation, the RFID devices will enable the controller to prevent the release of the undesirable cleaning fluid into the post-processing system. Still further advantages are achieved by including RFID devices with the cleaning fluid. Additional embodiments of the present invention include alternative devices and/or methods for determining the contents of the containers of cleaning fluid, including but not limited to electrical contact devices that may read and write digital data so long as the devices are in electrical contact.

Some embodiments of the present invention define a cleaning process in which the part is to be cleaned by two different fluids. One exemplary embodiment is the cleaning of a part 26 with a cleaning fluid 64 comprising TPM (as mentioned above). After the part 26 has been exposed sufficiently to the TPM cleaning fluid 64, the controller activates a pump device to pump the cleaning fluid from the post-processing system back into the container 110 or some other reservoir (within or remote from the post-processing system) such that the closed-loop cleaning fluid system is substantially evacuated of the cleaning fluid. The controller 60 then activates a second cleaning fluid release device to release into the closed-loop cleaning fluid system a second cleaning fluid, such as an aqueous cleaning fluid with or without surfactants, one non-limiting example of a surfactant being the surface active agent FC430. Second cleaning fluid may be released from any source, including but not-limited to a second container, by the second cleaning fluid release device which allows the part 26 to be exposed to the second cleaning fluid by at least the first fluid circulation device to further clean the part and/or remove residual amounts of the TPM cleaning fluid. Once the exposure to the second cleaning fluid is complete, the controller 60 activates a pump to substantially evacuate the closed-loop cleaning fluid system in a fashion similar to the evacuation of the original cleaning fluid. Using this method and similar methods, various embodiments of the present invention enable the cleaning of parts using multiple cleaning fluids and/or multiple cleaning processes. Furthermore, for embodiments in which a cleaning fluid is circulated into and out of a container, certain containers include an in-line filter within or associated with the container such that when the technician replaces the container, the filter is also replaced (or vice versa). Combining the filter and container into a single replaceable unit also allows the filter to be removed without substantially spilling the cleaning fluid or requiring the technician to come into contact with the cleaning fluid.

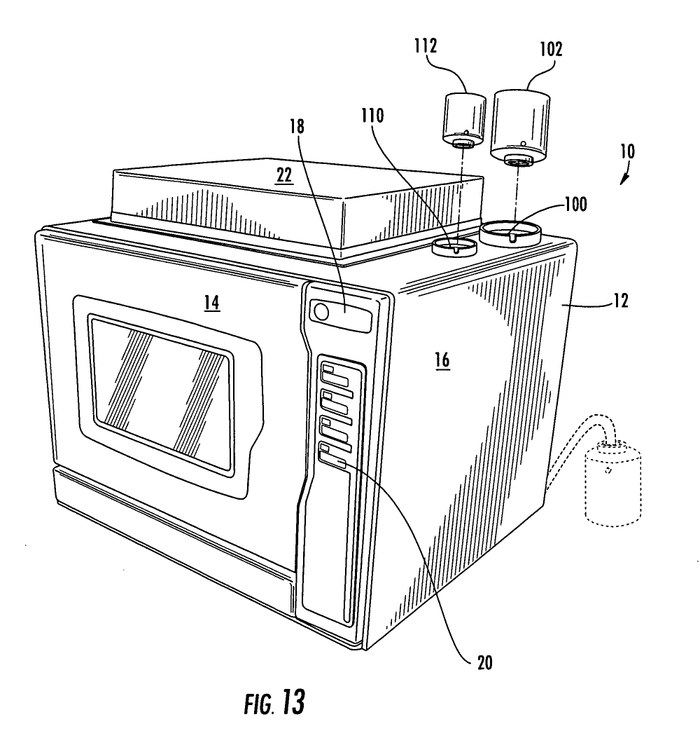

FIG. 13 is similar to FIG. 11 but also includes a receptacle 110 adapted to receive a container 112 of antifoam, such that the antifoam in the container is in selective fluid communication with the fluid circulation device, so that the antifoam may be selectively added to the cleaning fluid. The release of antifoam from the container 112 is controlled in a similar fashion to the release of cleaning fluid from the container 102, in that the controller determines when more antifoam is required based upon the measurements of the cleaning fluid property detector 98. Further embodiments of the present invention include the antifoam with the cleaning fluid in the container 102, and still further embodiments of the present invention require a technician to add antifoam on an as needed basis based upon observations of the post-processing system.

Accordingly, the present invention allows for quick, safe, and effective cleaning and/or curing of parts produced by SFF processes. Furthermore, the present invention facilitates automated processes for producing finished parts produced by SFF processes. In addition, the present invention provides for the extended use of cleaning fluids and convenient monitoring and replacement of cleaning fluids in post-processing systems.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

That which is claimed:

1. A method of post-processing a part produced by solid freeform fabrication (SFF), the method comprising:
positioning the part within a substantially watertight housing of a post-processing system;
exposing the part to cleaning fluid circulated within the housing; and
curing the part with actinic radiation within the housing,
wherein the part is cleaned and cured without removing the part from the housing.

2. A method according to claim 1, wherein positioning the part comprises using a part handling device to selectively remove the part from a SFF system and positioning the part in mechanical communication with a part retaining device within the housing.

3. A method according to claim 1, wherein positioning the part comprises placing the part within a cage of a part retaining device and placing a lid of the part retaining device in a position to generally restrict movement of the part relative to the part retaining device.

4. A method according to claim 1, wherein positioning the part further comprises closing a door of the housing by rotating the door about at least one of a vertical axis and a horizontal axis.

5. A method according to claim 1, wherein positioning the part further comprises closing a door of the housing by sliding the door in a direction that is generally orthogonal to at least one adjacent side of the housing.

6. A method according to claim 1 further comprising rotating the part about a first axis relative to the housing during the exposing and curing of the part.

7. A method according to claim 6 further comprising rotating the part about a second axis relative to the housing during the exposing and curing of the part, wherein the second axis is different than the first axis.

8. A method according to claim 1 further comprising drying the part after exposing the part to cleaning fluid and before curing the part with actinic radiation.

9. A method according to claim 8, wherein drying the part comprises circulating air around the part.

10. A method of post-processing a part produced by solid freeform fabrication (SFF), the method comprising:
positioning the part within a part retaining device within the housing of a post-processing system;
rotating the part about a first axis relative to the housing;
rotating the part about a second axis relative to the housing, wherein the second axis is different than the first axis; and
exposing the part to cleaning fluid circulated within the housing.

11. A method according to claim 10, wherein positioning the part comprises using a part handling device to selectively remove the part from a SFF system and positioning the part in mechanical communication with a part retaining device within the housing.

12. A method according to claim 10, wherein positioning the part comprises placing the part within a cage of the part retaining device and placing a lid of the part retaining device in a position to generally restrict movement of the part relative to the part retaining device.

13. A method according to claim 10, wherein positioning the part comprises placing the part retaining device within the housing of the post-processing system.

14. A method according to claim 10, wherein positioning the part within a part retaining device comprises retaining a build pad to which the part is removably joined.

15. A method of post-processing a part produced by solid freeform fabrication (SFF), the method comprising:
positioning the part within a housing of a post-processing system;
exposing the part to cleaning fluid circulated by a first fluid circulation device;
curing the part with actinic radiation from an actinic radiation source;
circulating the cleaning fluid with a second fluid circulation device without substantially exposing the part to the cleaning fluid,
wherein circulating the cleaning fluid comprises circulating the cleaning fluid in optical communication with the actinic radiation source to cure particles of previously uncured build material removed from the part by the cleaning fluid.

16. A method according to claim 15 further comprising automatically disabling the first fluid circulation device prior to activating the actinic radiation source.

17. A method according to claim 15 further comprising removing cleaning fluid from a surface positioned between the actinic radiation source and the part.

18. A method according to claim 15 further comprising drying the part after exposing the part to cleaning fluid and before curing the part with actinic radiation.

19. A method according to claim 15 further comprising detecting a cleaning fluid property and selectively transferring cleaning fluid from a container to at least the first fluid circulation device as a result of the detected cleaning fluid property.

20. A method according to claim 19 further comprising receiving information about the cleaning fluid in the container from an RFID tag associated with the container of cleaning fluid prior to selectively transferring cleaning fluid from a container to at least the first fluid circulation device.

21. A method according to claim 15 further comprising substantially evacuating the cleaning fluid from the post-processing system and releasing a second cleaning fluid into the post-processing system.

22. A method according to claim 15 further comprising removing a filter from the housing.

23. A method according to claim 22 further comprising removing a filtration portion of the filter from a housing portion of the filter.
